(19) United States
(12) Patent Application Publication
(10) Pub. No.: US 2026/0244274 A1
(43) Pub. Date: Aug. 20, 2026

(54) ELECTRONIC DEVICE

(71) Applicant: CARUX TECHNOLOGY PTE. LTD., APERIA (SG)

(72) Inventors: Yuan-Fu LIN, Tainan (Tainan Science Park) (TW); Hsien-Chang CHEN, Tainan (Tainan Science Park) (TW)

(21) Appl. No.: 19/460,515

(22) Filed: Jan. 27, 2026

(30) Foreign Application Priority Data
Feb. 17, 2025 (CN) 202510170420.2

(51) Int. Cl. G06F 3/01; G06F 3/041

(52) U.S. Cl. CPC G06F 3/016; G06F 3/041; G06F 2203/04105

(57) ABSTRACT

An electronic device is provided, including a touch module and an actuator module. The touch module includes a touch panel and a connecting member. The connecting member has a first surface and a second surface. The first surface is connected to the touch panel, and the first surface and the second surface are facing different directions. The actuator module includes an actuator member and a supporting member. The first end portion and the second end portion of the activation module are respectively connected to a third end portion and a fourth end portion of the supporting member. There is a space between the supporting member and the actuator member. In the first direction, the connecting member is connected to the connecting section of the supporting member, and a first gap that is greater than zero is formed between the connecting section and the second surface.

### CROSS REFERENCE TO RELATED APPLICATIONS

This application claims the benefit of China Patent Application No. 202510170420.2, filed Feb. 17, 2025, the entirety of which is incorporated by reference herein.

### TECHNICAL FIELD

The present disclosure relates to an electronic device, and, in particular, it relates to an electronic device having an actuator module.

### BACKGROUND

In recent years, technology has advanced, allowing electronic devices such as mobile phones, tablet computers, notebook computers, and smartphones to become more commonplace, and lots of electronic devices include touch functionality to make them easier for the user to operate. However, when the user touches the electronic device, he/she often cannot tell whether or not the touch function was activated, and excess force may be applied, causing damage to the electronic device. Therefore, how to address the aforementioned problem has become an important issue.

### BRIEF SUMMARY

An embodiment of the present disclosure provides an electronic device, including a touch module and an actuator module. The touch module includes a touch panel and a connecting member. The connecting member has a first surface and a second surface, the first surface is connected to the touch panel, and the first surface and the second surface are facing different directions. The actuator module includes an actuator member and a supporting member. The actuator member includes a first end portion and a second end portion. The supporting member includes a third end portion, a fourth end portion, and a connecting portion that is connected between the third end portion and the fourth end portion. The first end portion is connected to the third end portion, and the second end portion is connected to the fourth end portion. There is a space between the supporting member and the actuator member. The connecting portion includes a connecting section. In a first direction, the connecting member is connected to the connecting section, and a gap that is greater than zero is formed between the connecting section and the second surface of the connecting member.

### BRIEF DESCRIPTION OF DRAWINGS

The disclosure can be more fully understood by reading the subsequent detailed description and examples with references made to the accompanying drawings, wherein:

FIG. 1 is a cross-sectional view of an electronic device according to an embodiment of the present disclosure;

FIG. 2 is a schematic diagram of a touch module, a pressure sensor, a controller, and an actuator member in the electronic device according to an embodiment of the present disclosure;

FIG. 3A is a schematic diagram of a voltage output by the controller according to an embodiment of the present disclosure;

FIG. 3B is a schematic diagram of the comparison of the total noise between the electronic device with the first gap and the second gap and an electronic device without the first gap and the second gap;

FIG. 4A is a partial cross-sectional view of an electronic device according to another embodiment of the present disclosure;

FIG. 4B is a horizontal cross-sectional view of the electronic device along the position of the spacing member according to another embodiment of the present disclosure;

FIG. 5 is a partial cross-sectional view of an electronic device according to another embodiment of the present disclosure;

FIG. 6 is a partial cross-sectional view of an electronic device according to another embodiment of the present disclosure;

FIG. 7 is a partial cross-sectional view of an electronic device according to another embodiment of the present disclosure;

FIG. 8 is a partial cross-sectional view of an electronic device according to another embodiment of the present disclosure;

FIG. 9 is a partial cross-sectional view of an electronic device according to another embodiment of the present disclosure;

FIG. 10 is a partial cross-sectional view of an electronic device according to another embodiment of the present disclosure; and

FIGS. 11A to FIG. 11C are schematic diagrams of an electronic device according to another embodiment of the present disclosure.

### DETAILED DESCRIPTION

The making and using of the embodiments of the electronic device are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include”, “comprise” and “have” are used in an open-ended fashion, and thus should be interpreted to mean “include, but not limited to… ”. Thus, when the terms “include”, “comprise” and/or “have” are used in the description of the present disclosure, the corresponding features, areas, steps, operations and/or components would be pointed to existence, but not limited to the existence of one or a plurality of the corresponding features, areas, steps, operations and/or components.

In addition, in this specification, relative expressions are used. For example, “below” and “above” are used to describe the position of one element relative to another. It should be appreciated that if a device is flipped upside down, an element that is “below” will become an element that is “above”.

When the corresponding component (such as layer or area) is referred to “on another component (or the variant thereof)”, it may be directly on another component, or other component may exist between them. On the other hand, when the component is referred to “directly on another component (or the variant thereof)”, any component does not exist between them. Moreover, when a component is referred to “on another component (or the variant thereof)”, the component and the other component has a positional relationship in a top view direction, the component can be disposed above or below the other component, and the positional relationship is based on the orientation of the device.

In some embodiments of the disclosure, terms concerning attachments, coupling and the like, such as “connected”, refer to a relationship wherein structures are secured or attached to one another either directly or indirectly through intervening structures, unless expressly described otherwise.

It should be understood that, although the terms “first”, “second”, etc. can be used herein to describe various elements, layers and/or sections, these elements, layers and/or sections should not be limited by these terms. These terms are only used to distinguish one element layer or section from another element, layer or section. Thus, a first element, layer or section discussed below could be termed a second element, layer or section without departing from the teachings of the present disclosure. For brevity, the terms “first”, “second”, etc. may not be used in the specification. The first element and/or the second element in claims can refer to any element that meets the description in the specification without departing from the spirit and scope of the invention as defined by the appended claims.

The terms “about” and “substantially” typically mean +/−15% of the stated value, for example, +/−10%, +/−5%, +/−3%, +/−2%, +/−1%, or +/−0.5% of the stated value. The stated value of the present disclosure is an approximate value. When there is no specific description to the terms “about” and “substantially”, the stated value includes the meaning of “about” or “substantially”. Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise. Moreover, for brevity, some elements can be suitably omitted in the figures.

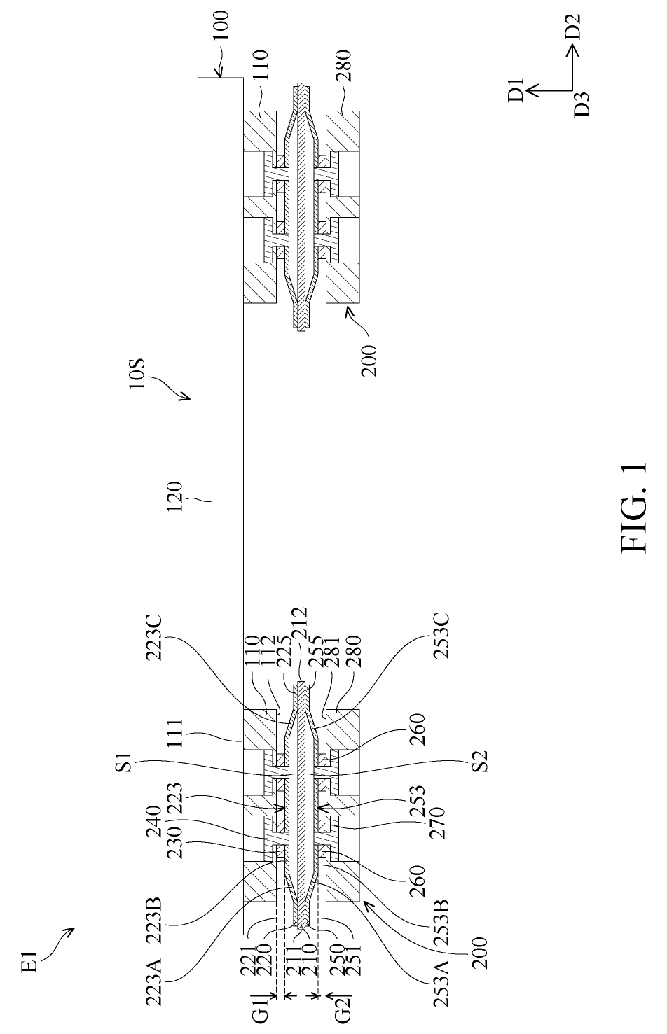

FIG. 1 is a schematic diagram of an electronic device E1 according to an embodiment of the present disclosure. The electronic device E1 can include a display device, a backlight device, an antenna device, a sensing device, or a tiled device. The display device can be a non-self-emitting type display device or a self-emitting type display device. The antenna device can be a liquid crystal type antenna device or a non-liquid crystal type antenna device. The sensing device can be a sensing device for sensing capacitance, light, heat, or ultrasonic, but it is not limited thereto. The tiled device can be a tiled display device or a tiled antenna device, but it is not limited thereto. The electronic device can be a bendable electronic device or a flexible electronic device. The electronic device can include various electronic components. The electronic device can include a passive element and an active element, such as a capacitance, a resistance, an inductance, a diode, a transistor, an integrated chip, a memory, or a sensor, but it is not limited thereto. The diode can include a light-emitting diode or a photoelectric diode. For example, the light-emitting diode can include an organic light-emitting diode (OLED), a mini LED, a micro LED, or a quantum dot LED, but it is not limited thereto. It should be noted that, the electronic device can be a combination having one or more aforementioned devices, but it is not limited thereto.

FIG. 1 is a cross-sectional view of the electronic device E1 according to an embodiment of the present disclosure. As shown in FIG. 1, the electronic device E1 primarily includes a touch module 100 and at least one actuator module 200. The actuator module 200 can be connected to the touch module 100. When the user applies an external force to press the touch module 100, the actuator module 200 can provide a pushing force to the touch module 100, and the touch module 100 vibrates accordingly. Thus, the user can obtain the touch feedback. The touch module 100 can be connected to at least one actuator module 200. According to some embodiments, the touch module 100 can be connected to multiple actuator modules 200. For illustration purposes, the touch module 100 in FIG. 1 is connected to two actuator modules 200, but it is not intended to limit the present disclosure.

The touch module 100 includes a connecting member 110 (a first connecting member 110) and a touch panel 120. The first connecting member 110 has a first surface 111 and a second surface 112. The first surface 111 faces the touch panel 120, and the touch panel 120 is connected to the first surface 111. For example, the touch panel 120 can be affixed to the first connecting member 110 by adhering or locking, but it is not limited thereto.

The second surface 112 and the first surface 111 are facing different directions, and the actuator module 200 can be connected to the second surface 112. In this embodiment, as shown in FIG. 1, the first surface 111 and the second surface 112 are opposite.

The actuator module 200 can be a piezoelectric activator or a linear resonant actuator. As shown in FIG. 1, in this embodiment, the actuator module 200 can be a piezoelectric actuator, and can include an actuator member 210 and a supporting member (a first supporting member) 220. According to some embodiments, the actuator module 200 can further include a second supporting member 250. In a first direction D1, the actuator member 210 is disposed between the first supporting member 220 and the second supporting member 250. The actuator member 210 can be connected to the opposite end portions 221 and 225 of the first supporting member 220 via its opposite end portions 211 and 212, and the actuator member 210 can be connected to the opposite end portions 251 and 255 of the second supporting member 250 via its opposite end portions 211 and 212.

The actuator member 210 can include piezoelectric material, and can include a first end portion 211 and a second end portion 212. When a voltage is applied on the actuator member 210, the length of the actuator member 210 is changed. The first supporting member 220 can include a material with sufficient stiffness yet flexible (such as titanium alloys), and can include a third end portion 221, a fourth end portion 225, and a connecting portion 223. The connecting portion 223 is disposed between the third end portion 221 and the fourth end portion 225, and the third end portion 221 and the fourth end portion 225 can respectively affixed to the first end portion 211 and the second end portion 212 of the actuator member 210. Therefore, when the length of the actuator member 210 is changed, the first supporting member 220 can be driven and deformed along the first direction D1, and the actuator module 200 can vibrate in the first direction D1. The first direction D1 is substantially perpendicular to the direction of the length of the actuator member 210 (i.e. a second direction D2 in the figures). In FIG. 1, the touch module 100 is disposed on the actuator module 200 along the first direction D1, and the first direction D1 is the vibration direction of the actuator module 200.

As shown in FIG. 1, in detail, the connecting portion 223 of the first supporting member 220 includes a first inclined section 223A, a connecting section 223B, and a second inclined section 223C. The first inclined section 223A is connected to the third end portion 221 of the first supporting member 220, an extended toward the first connecting member 110. The second inclined section 223C is connected to the fourth end portion 225 of the first supporting member 220, and extended toward the first connecting member 110. The connecting section 223B and the first inclined section 223A extend in different directions, and the connecting section 223B and the second inclined section 223C extend in different directions. In detail, the connecting section 223B can be a horizontal section, and its extending direction is the second direction D2. The second direction D2 and the first direction D1 can be different. For example, the second direction D2 and the first direction D1 can be perpendicular. The connecting section 223B can be disposed between the first inclined section 223A and the second inclined section 223C and connected to them. Therefore, there is a space S1 between the connecting portion 223 and the actuator member 210. According to some embodiments, the connecting section 223B of the first supporting member 220 can be defined as a section that is connected to the first connecting member 110 of the touch module 100.

Referring to FIG. 1, the electronic device E1 can further include at least one spacing member 230. In the first direction D1, the spacing member 230 is disposed between the first connecting member 110 and the connecting portion 223 of the first supporting member 220, and is in contact with the second surface 112 and the connecting section 223B. Therefore, the first connecting member 110 and the first supporting member 220 are separated by the spacing member 230, and a first gap G1 that is greater than zero can be formed between the second surface 112 of the first connecting member 110 and the connecting section 223B of the first supporting member 220 in the first direction D1. For example, the first gap G1 can be in a range between 0.01 millimeters and 50 millimeters, in a range between 0.05 millimeters to 20 millimeters, in a range between 0.1 millimeters to 10 millimeters (0.1mm < G1 < 10mm), or in a range between 0.2 millimeters to 5 millimeters.

Referring to FIG. 1, the electronic device E1 can further include at least one first fixing member 240. The first fixing member 240 can pass through the first connecting member 110 and the spacing member 230 along the first direction D1 and engage with the connecting section 223B of the first supporting member 220. Therefore, in the first direction D1, the first connecting member 110 and the connecting section 223B of the first supporting member 220 are connected to each other via the first fixing member 240.

Referring to FIG. 1, the electronic device E1 can further include another supporting member (a second supporting member) 250 and another connecting member (a second connecting member) 280. In the first direction D1, the actuator member 210 is disposed between the first supporting member 220 and the second supporting member 250. The second supporting member 250 and the second connecting member 280 are connected to each other along the first direction D1. The second supporting member 250 and the first supporting member 220 can include similar structure. Similarly, the second supporting member 250 can include a material with sufficient stiffness yet flexible (such as titanium alloys), and can include a fifth end portion 251, a sixth end portion 255, and a connecting portion 253. The connecting portion 253 is disposed between the fifth end portion 251 and the sixth end portion 255, and the fifth end portion 251 and the sixth end portion 255 are respectively affixed to the first end portion 211 and the second end portion 212 of the actuator member 210. The actuator member 210 can be connected to the opposite end portions 251 and 255 of the second supporting member 250 via its opposite end portions 211 and 212.

Referring to FIG. 1, similar to the first supporting member 220, the connecting portion 253 of the second supporting member 250 can include a first inclined section 253A, a connecting section 253B, and a second inclined section 253C. The first inclined section 253A is connected to the fifth end portion 251 of the second supporting member 250, and extended toward the second connecting member 280. The second inclined section 253C is connected to the sixth end portion 255 of the second supporting member 250, and extended toward the second connecting member 280. The connecting section 253B can be a horizontal section, extended along the second direction D2, and disposed between the first inclined section 253A and the second inclined section 253C and connected to them. Therefore, there is a space S2 between the connecting portion 253 and the actuator member 210.

Referring to FIG. 1, the electronic device E1 can further include a spacing member 260. The second connecting member 280 has a fourth surface 281 facing the actuator member 210. The spacing member 260 is disposed between the second connecting member 280 and the connecting portion 253 of the second supporting member 250, and is in contact with the fourth surface 281 and the connecting section 253. Therefore, the second connecting member 280 and the second supporting member 250 can be separated by the spacing member 260, and a second gap G2 that is greater than zero can be formed between the fourth surface 281 of the second connecting member 280 and the connecting section 253B of the second supporting member 250 in the first direction D1. For example, the second gap G2 can be in a range between 0.01 millimeters and 50 millimeters, in a range between 0.05 millimeters to 20 millimeters, in a range between 0.1 millimeters to 10 millimeters (0.1mm < G1 < 10mm), or in a range between 0.2 millimeters to 5 millimeters. According to some embodiments, the second gap G2 can be the same as the first gap G1. According to some embodiments, the second gap G2 can be different from the first gap G1.

The second connecting member 280 and the first connecting member 110 can include similar structure. The electronic device E1 can further include a second fixing member 270. The second fixing member 270 can pass through the second connecting member 280 and the spacing member 260 along the first direction D1 and engage with the connecting section 253B of the second supporting member 250. Therefore, in the first direction D1, the second connecting member 280 and the connecting section 253B of the second supporting member 250 can be connected to each other via the second fixing member 270.

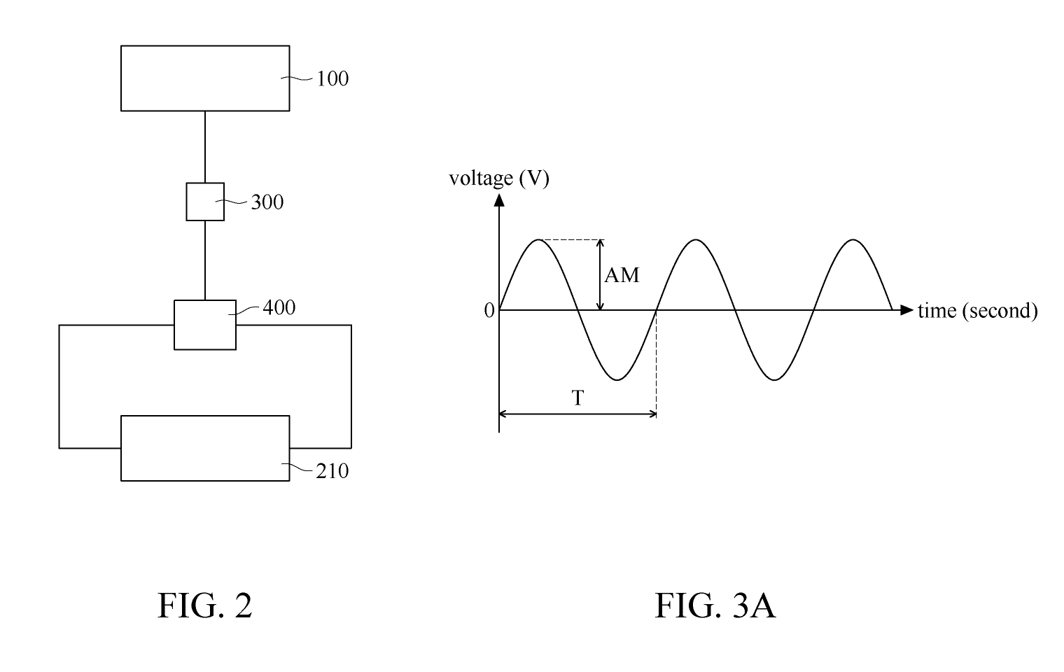

Referring to FIG. 2, in this embodiment, the electronic device E1 can further includes a pressure sensor 300 and a controller 400. The pressure sensor 300 can be electrically connected to the touch module 100 and the controller 400, and the controller 400 can be electrically connected to the electrodes on the actuator member 210 (for example, by using the wires or the flexible printed circuits to connect the opposite end portions of the actuator member 210).

When the user applies the external force to press the touch module 100 (for example, in FIG. 1, the surface 10S of the touch panel 120 of the touch module 100 is pressed), the pressure sensor 300 can detect the aforementioned external force and transmit a signal to the controller 400. After the controller 400 receives the signal, it can provide a voltage to the actuator member 210, the length of the actuator member 210 can be therefore changed, and the actuator member 210 can drive the first supporting member 220 and the second supporting member 250 to deform along the first direction D1. Thus, the touch module 100 that is connected to the actuator module 200 can vibrate due to the pushing force of the actuator module 200, such as vibrate along the first direction, and the user can obtain the touch feedback. The pressed surface 10S is a surface constituted by the direction D2 and the direction D3, and the vibration of the touch module 100 is along the first direction D1.

As shown in FIG. 1, since the first gap G1 is formed between the second surface 112 of the first connecting member 110 and the connecting section 223B of the first supporting member 220, the impact between the connecting section 223B of the first supporting member 220 and the touch module 100 when the first supporting member 220 is deformed along the first direction D1 can be prevented, the noise can be reduced or the damage of the first supporting member 220 can be avoided. Similarly, since the second gap G2 is formed between the fourth surface 281 of the second connecting member 280 and the connecting section 253B of the second supporting member 250, the impact between the connecting section 253B of the second supporting member 250 and the second connecting member 280 when the second supporting member 250 is deformed along the first direction D1 can be prevented, the noise can be reduced or the damage of the second supporting member 250 can be avoided.

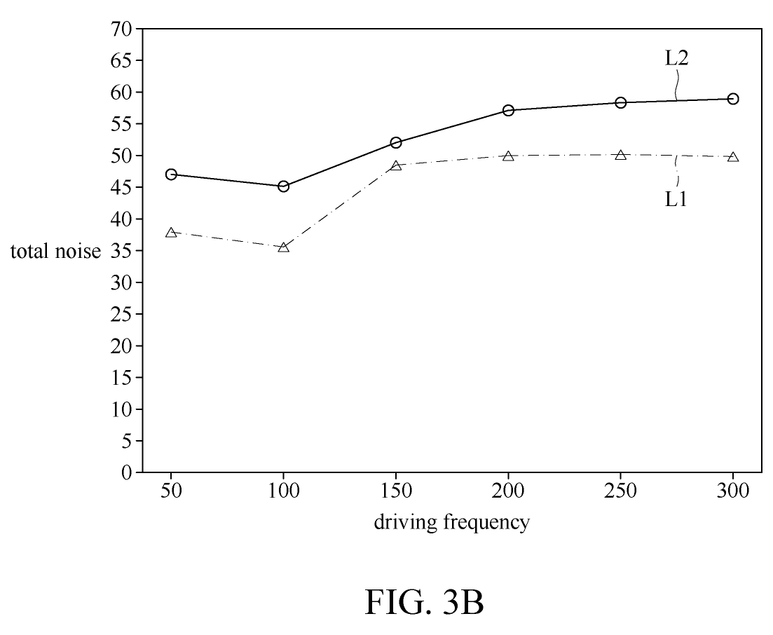

Referring to FIG. 3A, the controller 400 can output the voltage with the specific driving amplitude AM at the specific driving frequency (i.e. the reciprocal of the period T). For example, the amplitude AM can be in a range between 1 volt to 150 volt (such as 120 volt). FIG. 3B is a schematic diagram of the relationship between the driving frequency and the noise, wherein the curve L1 represents the electronic device E1 according to the present application, in which the first gap G1 is formed between the second surface 112 of the first connecting member 110 and the connecting section 223B of the first supporting member 220 and the second gap G2 is formed between the fourth surface 281 of the second connecting member 280 an the connecting section 253B of the second supporting member 250. The curve L2 in FIG. 3B represents the electronic device without the first gap G1, and the second surface 112 of the first connecting member 110 is in directly contact with the connecting section 223B of the first supporting member 220 and the fourth surface 281 of the second connecting member 280 is in directly contact with the connecting section 253B of the second supporting member 250. As shown in the curve L1 of FIG. 3B, owing to the first gap G1 and/or the second gap G2, in ever driving frequencies, the noise of the electronic device E1 can be efficiently reduced.

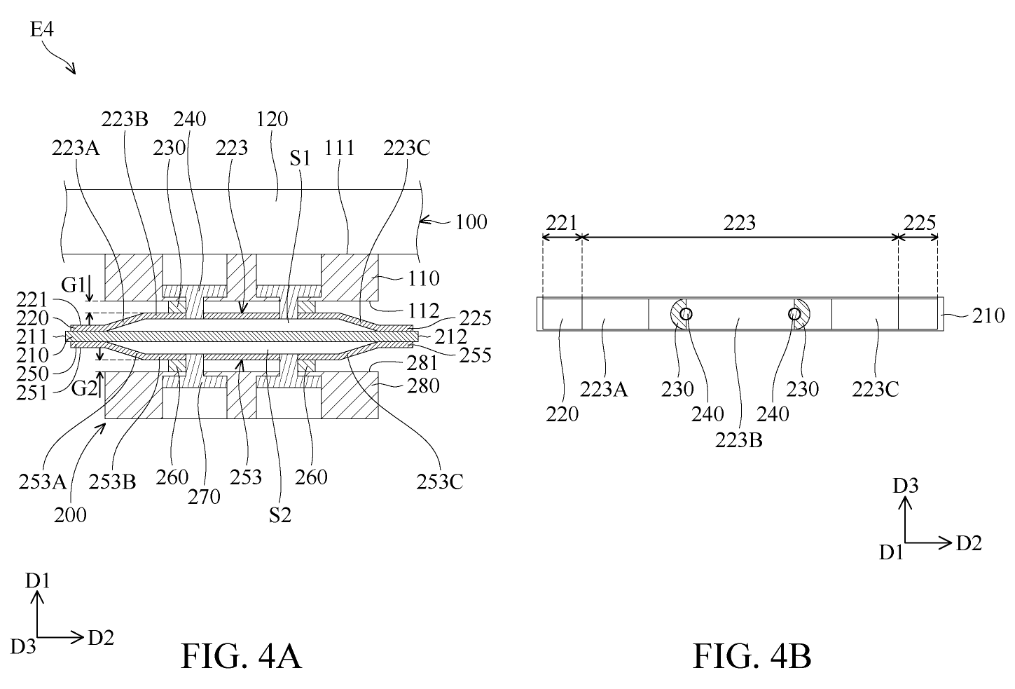

FIG. 4A is a partial cross-sectional view of an electronic device E4 according to an embodiment of the present disclosure, and FIG. 4B is a horizontal cross-sectional view of the electronic device E4 along the position of the spacing member 230. The main difference between FIGS. 4A, 4B and FIG. 1 is in that each of the spacing member 230 and the spacing member 260 has a semicircular structure, so that the cost of the material can be reduced and the manufacturing process can be simplified, and the weight of the electronic device E4 can be further reduced. The description of the other components in FIGS. 4A and FIG. 4B can refer to FIG. 1, so that the features thereof are not repeated in the interest of brevity.

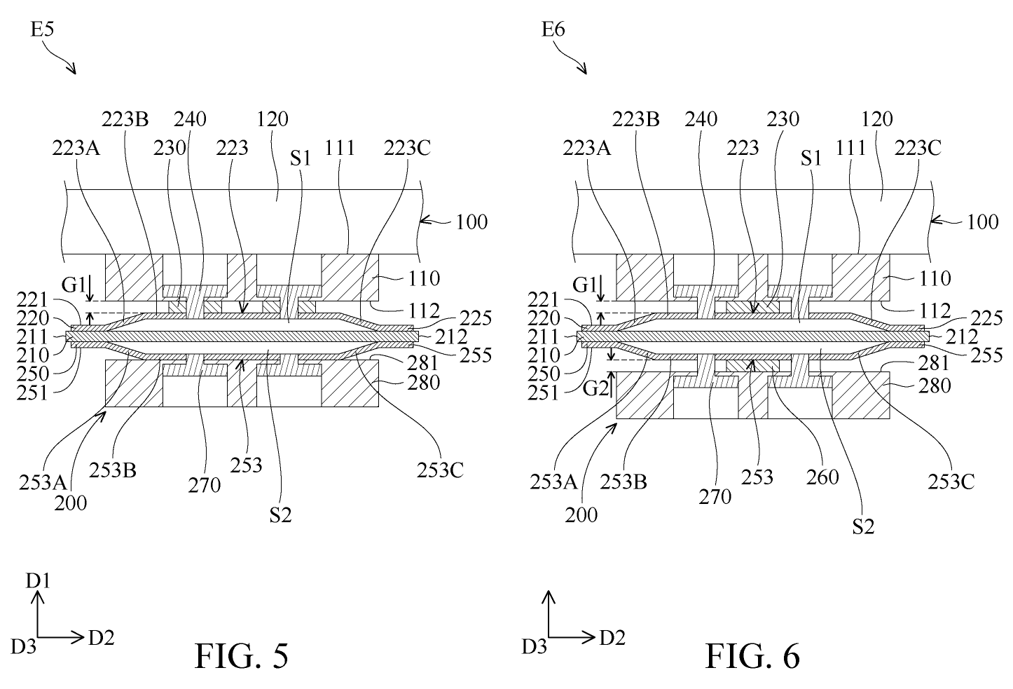

In some embodiments, one of the spacing member 230 and the spacing member 260 can be omitted to reduce the thickness of the electronic device. For example, FIG. 5 is a partial cross-sectional view of an electronic device E5 according to an embodiment of the present disclosure. The main difference between FIGS. 5 and FIG. 1 is in that, there is no spacing member 260 in FIG. 5. As shown in FIG. 5, the spacing member 260 can be omitted, so that the fourth surface 281 of the second connecting member 280 can be in directly contact with the connecting section 253B of the second supporting member 250. The description of the other components in FIG. 5 can refer to FIG. 1, so that the features thereof are not repeated in the interest of brevity.

FIG. 6 is a partial cross-sectional view of an electronic device E6 according to an embodiment of the present disclosure. The main difference between FIGS. 6 and FIG. 1 is in that, in FIG. 6, the first fixing member 240 does not pass through the spacing members 230, and the second fixing member 270 does not pass through the spacing members 260. The spacing member 230 can be disposed between the multiple spacing members 230 of the electronic device E6. For example, the spacing member 230 can be disposed between two adjacent first fixing members 240. The spacing member 260 can be disposed between the multiple spacing members 270 of the electronic device E6. For example, the spacing member 260 can be disposed between two adjacent first fixing members 270.

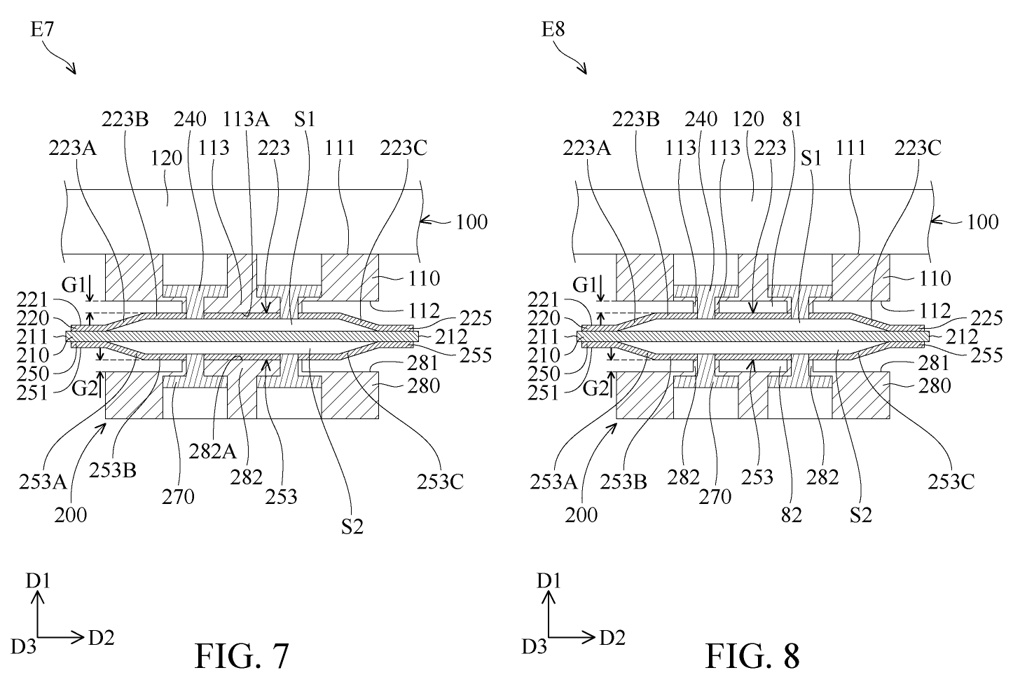

FIG. 7 is a partial cross-sectional view of an electronic device E7 according to an embodiment of the present disclosure. The main difference between FIGS. 7 and FIG. 1 is in that the spacing member 230 and the spacing member 260 are omitted, and the first connecting member 110 of the touch module 100 includes a first protruding portion 113 protruding toward the actuator module 200. The first protruding portion 113 includes a third surface 113A, and the third surface 113A faces the first supporting member 220 and is connected to the second surface 112. Therefore, in the first direction D1, compared with the second surface 112, the third surface 113A is closer to the first supporting member 220. In this embodiment, the third surface 113A can be in directly contact with the connecting section 223B of the first supporting member 220.

As shown in FIG. 7, the first fixing member 240 can pass through the first protruding portion 113 of the first connecting member 110 and engage with the connecting section 223B of the first supporting member 220, so that the first connecting member 110 and the connecting section 223B of the first supporting member 220 are connected to each other via the first fixing member 240 in the first direction D1. Since the first connecting member 110 has the first protruding portion 113, so that the first gap G1 that is greater than zero can be formed between the second surface 112 of the first connecting member 110 and the connecting section 223B of the first supporting member 220. For example, the first gap G1 can be in a range between 0.1 millimeters and 10 millimeters (0.1mm < G1 < 10mm).

As shown in FIG. 7, similarly, the second connecting member 280 includes a protruding portion 282 protruding toward the actuator module 200. The protruding portion 282 includes a fifth surface 282A, and the fifth surface 282A faces the second supporting member 250 and is connected to the fourth surface 281. Therefore, in the first direction D1, compared with the fourth surface 281, the fifth surface 282A is closer to the second supporting member 250. In this embodiment, the fifth surface 282A can be in directly contact with the connecting section 253B of the second supporting member 250.

As shown in FIG. 7, the second fixing member 270 can pass through the second protruding portion 282 of the second connecting member 280 and engage with the connecting section 253B of the second supporting member 250, so that the second connecting member 280 and the connecting section 253B of the second supporting member 250 are connected to each other via the second fixing member 270 in the first direction D1. Since the second connecting member 280 has the protruding portion 282, so that the second gap G2 that is greater than zero can be formed between the fourth surface 281 of the second connecting member 280 and the connecting section 253B of the second supporting member 250. For example, the second gap G2 can be in a range between 0.1 millimeters and 10 millimeters (0.1mm < G2 < 10mm).

FIG. 8 is a partial cross-sectional view of an electronic device E8 according to an embodiment of the present disclosure. The main difference between FIGS. 5 and FIG. 7 is in that, the first connecting member 110 includes a plurality of first protruding portions 113 with a space 81 between them, and the second connecting member 280 includes a plurality of protruding portions 282 with a space 82 between them. The multiple first fixing members 240 of the electronic device E8 can pass through the first protruding portions 113 in the one-on-one manner, and the multiple second fixing members 270 can pass through the protruding portions 282 in the one-on-one manner. For illustration purposes, FIG. 8 shows that the first connecting member 110 includes two adjacent protruding portions 113, and the two adjacent protruding portions 113 have a space 81 between them in the second direction D2. The second connecting member 280 includes two adjacent protruding portions 282, and the two adjacent protruding portions 282 has a space 82 between them in the second direction D2.

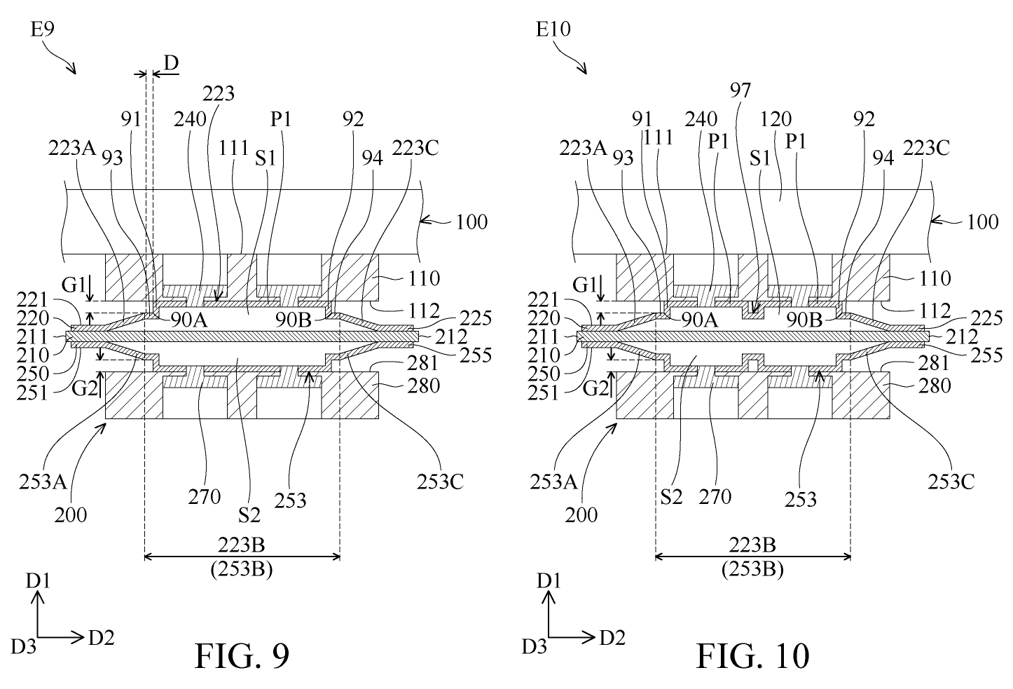

FIG. 9 is a partial cross-sectional view of an electronic device E9 according to an embodiment of the present disclosure. The main difference between FIG. 9 and FIG. 1 is in that, there is no spacing member 230 and spacing member 260 in FIG. 9, and the first G1 between the connecting section 223B and the second surface 112 of the first connecting member 110 is formed by raising the first supporting member 220. In detail, referring to FIG. 9, in another embodiment of the present disclosure, in the connecting portion 223 of the first supporting member 220, the connecting section 223B can include a second protruding portion P1, a first sub-protrusion connecting section 91, and a second sub-protrusion connecting section 92. The second protruding portion P1 can protrude toward the first connecting member 110. The extending directions of the first sub-protrusion connecting section 91 and the second sub-protrusion connecting section 92 are the first direction D1. The extending direction of the second protruding portion P1 is the second direction D2. The first sub-protrusion connecting section 91 is connected between the first inclined section 223A and the second protruding portion P1 at a first connecting point 90A, and the second sub-protrusion connecting section 92 is connected between the second protruding portion P1 and the second inclined section 223C at a second connecting point 90B.

As shown in FIG. 9, according to an embodiment, the connecting section 223B further include a sub-connecting section 93 connected between the first inclined section 223A and the first sub-protrusion connecting section 91, and the extending direction of the sub-connecting section 93 is the second direction D2. The connecting section 223B further include a sub-connecting section 94 connected between the second inclined section 223C and the second sub-protrusion connecting section 92, and the extending direction of the sub-connecting section 94 is the second direction D2.

In FIG. 9, the first gap G1 can be formed between the first connecting point 90A of the connecting section 223B and the second surface 112 of the first connecting member 110, and the first gap G1 can be formed between the second connecting point 90B and the connecting section 223C and the second surface 112 of the first connecting member 110. According to some embodiments, in the condition of the sub-connecting section 93 and the sub-connecting section 94 are disposed, the first gap G1 is formed between the sub-connecting section 93 and the second surface 112 of the first connecting member 110, and the first gap G1 is formed between the sub-connecting section 94 and the second surface 112 of the first connecting member 110.

Referring to FIG. 9, the second protruding portion P1 protrudes toward the first connecting member 110. Therefore, the distance between the second protruding portion P1 and the second surface 112 of the first connecting member 110 is less than the shortest distance between the first and second inclined section 223A, 223C and the second surface 112. Since the connecting section 223B of the first supporting member 220 includes the second protruding portion P1, the first gap G1 can be formed between the second surface 112 of the first connecting member 110 and the connecting section 223B of the first supporting member 220. For example, the first gap G1 can be in a range between 0.1 millimeters and 10 millimeters (0.1mm < G1 < 10mm).

As shown in FIG. 9, in this embodiment, in the second direction D2, a distance D between the first inclined section 223A of the first supporting member 220 and the second protruding portion P1 can be in a range between 0.5 millimeters and 20 millimeters, in a range between 1 millimeter and 20 millimeters (1mm < the distance D < 20mm), or in a range between 0.8 millimeters and 10 millimeters. Similarly, in the second direction, a distance (not labelled) is between the second inclined section 223A of the first supporting member 220 and the second protruding portion P1. For example, this distance can be in a range between 0.5 millimeters and 20 millimeters, in a range between 1 millimeter and 20 millimeters, or in a range between 0.8 millimeters and 10 millimeters, and can be the same as or different from the distance D.

As shown in FIG. 9, the second supporting member 250 can include a structure similar to the first supporting member 220. That is, the second supporting member 250 can include a second protruding portion, a first sub-protrusion connecting section, a second sub-protrusion connecting section and sub-connecting sections on the opposite sides. The second protruding portion of the second supporting member 250 can protrude toward the second connecting member 280. Since the second supporting member 250 and the first supporting member 220 has the similar or same structure, the second gap G2 can be formed between the fourth surface 281 of the second connecting member 280 and the connecting section 253B of the second supporting member 250, and the features thereof are not repeated in the interest of brevity. For example, the second gap G2 can be in a range between 0.1 millimeters and 10 millimeters (0.1mm < G2 < 10mm).

FIG. 10 is a partial cross-sectional view of an electronic device E10 according to an embodiment of the present disclosure. The main difference between FIGS. 10 and FIG. 9 is in that the connecting section 223B of the first supporting member 220 includes two adjacent second protruding portions P1 and a depression portion 97, and the depression portion 97 is connected between two adjacent second protruding portions P1. In the first supporting member 220, the second protruding portions P1 protrude toward the first connecting member 110, and the depression portion 97 is depressed toward the direction away from the first connecting member 110. Similar to the first supporting member 220, the connecting section 253B of the second supporting member 250 includes two adjacent protruding portions and a depression portion (not labelled), and the depression portion is connected between two adjacent protruding portions. The protruding portions of the second supporting member 250 protrude toward the second connecting member 280, and the depression portion is depressed toward the direction away from the second connecting member 280. The second supporting member 250 can include the similar or same structure as the first supporting member 220, so that the features thereof are not repeated in the interest of brevity.

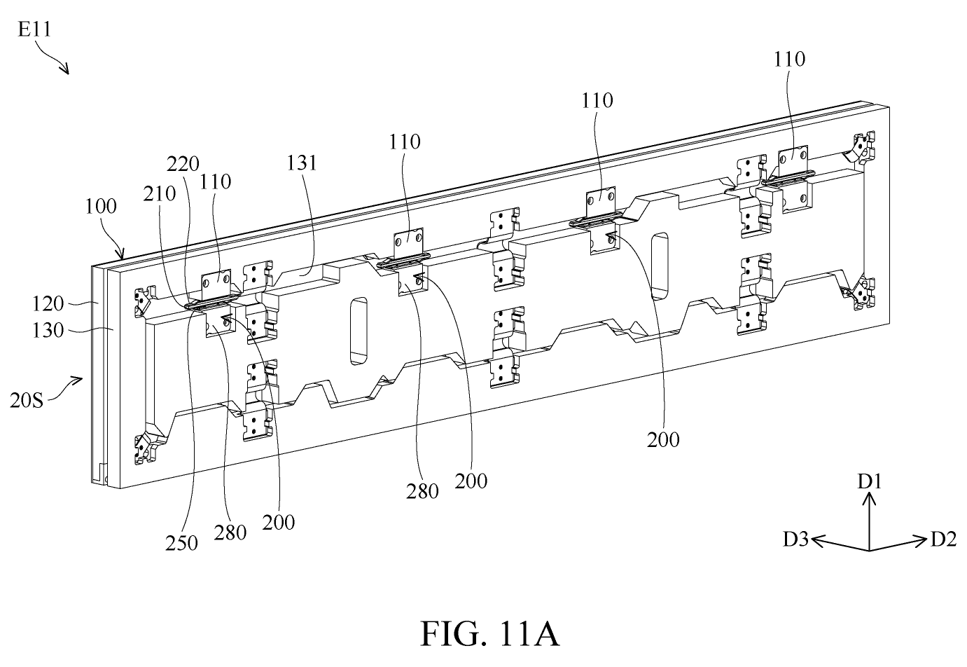

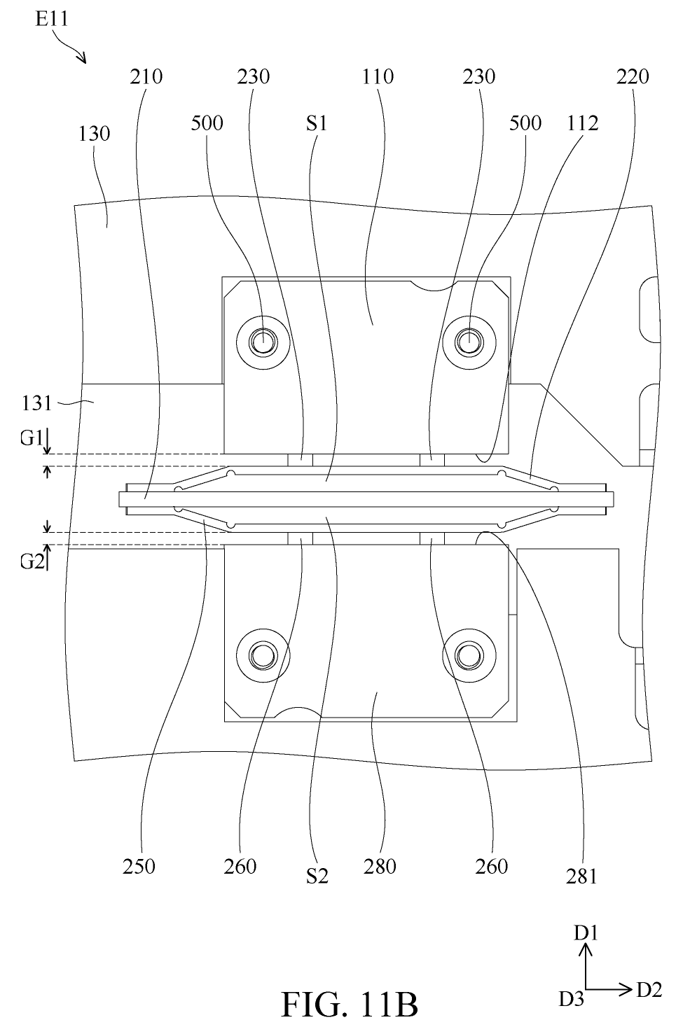

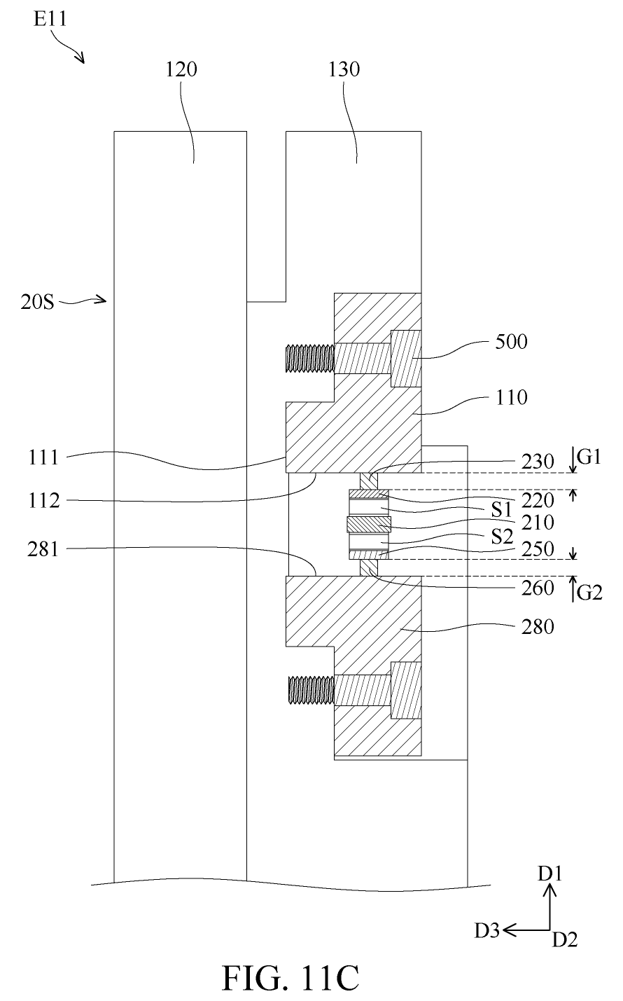

Referring to FIGS. 11A to FIG. 11C, an electronic device E11 according to another embodiment of the present disclosure primarily includes a touch module 100 and at least one actuator module 200, wherein the touch module 100 includes at least one first connecting member 110, a touch panel 120, and a housing 130. The main difference between FIGS. 11A and FIG. 1 is in that, the relative position between the actuator member and the touch surface of the touch panel 120 is different.

In FIG. 1, the touch surface 10S (i.e. the pressed surface) is the surface constituted by the direction D2 and the direction D3, and the actuator module 200 is disposed at the position to make the surface of the actuator member 210 being parallel to the touch surface 10S. Therefore, the vibration direction of the actuator member 210 and the touch panel 120 is D1. That is, the vibration direction D1 is perpendicular to the touch surface 10S. However, in FIG. 11A, the touch surface 20S (i.e. the pressed surface) is the surface constituted by the direction D1 and the direction D2, and the actuator module 200 is disposed at the position to make the surface of the actuator member 210 being the surface constituted by the direction D2 and the direction D3. That is, the touch surface 20S and the surface of the actuator member 210 are perpendicular. Therefore, the vibration direction of the actuator member 210 and the touch panel 120 is D1. That is, the vibration direction D1 is parallel to the touch surface 20S.

Furthermore, the structure of the actuator module 200 in FIG. 11A can refer to the structure of the actuator module 200 in FIG. 1, so that the features thereof are not repeated in the interest of brevity. In FIGS. 11A to FIG. 11C, the connection relationship between the first connecting member 110 and the actuator module 200 and the connection relationship between the second connecting member 280 and the actuator module 200 can refer to the embodiments in FIGS. 1 and FIG. 4 to FIG. 10, so that the features thereof are not repeated in the interest of brevity. For example, the arrangement of the actuator module 200 in FIG. 1 can be changed to the relative position relationship between the actuator module 200 and the touch module 100 shown in FIG. 11A, and the structure of the actuator module 200 uses the components shown in FIG. 1, such as the actuator module, the spacing member, the fixing member, etc. For example, the arrangement of the actuator module 200 in FIG. 7 can be changed to the relative position relationship between the actuator module 200 and the touch module 100 shown in FIG. 11A, and the structure of the actuator module 200 uses the components shown in FIG. 7, such as the protruding portion, the fixing member, etc.

It should be noted that, although FIGS. 11A to FIG. 11C do not show the first fixing member 240 and the second fixing member 270 due to the viewing angle (for example, FIG. 11B is a rear view of the electronic device E11, and the first fixing member 240 and the second fixing member 270 are covered by the first connecting member 110 and the second connecting member 280 respectively), the electronic device E11 in this embodiment can also include the first fixing member 240 and the second fixing member 270, and theirs positions can refer to FIG. 1.

As shown in FIG. 11C, in this embodiment, the touch panel 120 is connected to the housing 130, and the first connecting member 110 can be affixed to the housing 130 by the locking member 500. The first surface 111 of the first connecting member 110 is connected to the touch panel 120 via the housing 130. The touch panel 120 has the surface 20S that is used to press, and the housing 130 is connected to the surface opposite to the surface 20S. Similar to the FIG. 1, when the user presses the surface 20S of the touch panel 120 of the touch module 100, the length of the actuator member 210 can be changed due to the voltage, and the actuator member 210 can drive the first supporting member 220 to deform along the first direction D1. Therefore, the actuator module 200 can vibrate in the first direction D1, and drive the touch module 100 that is connected to the actuator module 200 to vibrate in the first direction D1. The difference from the FIG. 1 is in that, in FIG. 11A, the pressed surface 20S is the surface constituted by the direction D2 and the direction D3, and the vibration of the touch module 100 is along the first direction D1.

As shown in FIG. 11C, the first connecting member 110 includes the first surface 111 and the second surface 112, and the first surface 111 and the second surface 112 are adjacently disposed. The first surface 111 of the first connecting member 110 faces the touch panel 120, and the first surface 111 of the first connecting member 110 is connected to the touch panel 120. The second surface 112 of the first connecting member 110 faces the first supporting member 220 of the actuator module 200. The first gap G1 is formed between the connecting section 223B of the first supporting member 220 and the second surface 112 of the connecting member 110, and the first gap G1 is greater than zero. The locking member 500 passes through the first connecting member 110 through the third direction D3 and engages to the housing 130. Thus, in the third direction D3, the first connecting member 110 and the touch module 110 are connected to each other via the locking member 500 and the housing 130. The third direction D3 is different from the first direction D1. For example, an included angle between the first surface 111 and the second surface 112 can be about 90 degrees, and the third direction D3 can be substantially perpendicular to the first direction D1. According to some embodiments, the first direction D1, the second direction D2, and the third direction D3 are perpendicular to each other.

In this embodiment, as shown in FIG. 11A, the housing 130 of the touch module 100 includes at least one accommodating portion 131. According to some embodiments, at least a portion of the connecting member 110 can be accommodated in the accommodating portion 131. According to some embodiments, the first connecting member 110 and the second connecting member 280 of the actuator module 200 can be accommodated in the accommodating portion 131 and can be fixed relative to the housing 130. Therefore, the thickness of the electronic device E11 in the third direction D3 can be reduced, and the miniaturization of the electronic device E11 can be facilitated.

The features between the aforementioned embodiments can be used or combined as long as they do not violate or conflict the spirit of the present application.

In summary, an embodiment of the present disclosure provides an electronic device, including a touch module and an actuator module. The connecting member of the touch module is connected to the connecting section of the supporting member of the actuator module, and the gap that is greater than zero is formed between the connecting section of the supporting member and the surface of the connecting member. Therefore, the impact on the touch module due to the vibration of the supporting member can be prevented, the noise created by the vibration can be reduced, and the damage of the supporting member can be avoided.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the disclosure has been described by way of example and in terms of preferred embodiment, it should be understood that the disclosure is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An electronic device, comprising:
a touch module, comprising:
a touch panel; and
a connecting member, having a first surface and a second surface, wherein the first surface of the connecting member is connected to the touch panel, and the first surface and the second surface are facing different directions; and
an actuator module, comprising:
an actuator member, comprising a first end portion and a second end portion; and
a supporting member, comprising a third end portion, a fourth end portion, and a connecting portion, the connecting portion is connected between the third end portion and the fourth end portion, the first end portion of the actuator member is connected to the third end portion of the supporting member, the second end portion of the actuator member is connected to the fourth end portion of the supporting member, and a space is between the supporting member and the actuator member,
wherein the connecting portion comprises a connecting section, in a first direction, the connecting member of the touch module is connected to the connecting section of the supporting member, a first gap is formed between the connecting section and the second surface of the connecting member, and the first gap is greater than zero.

2. The electronic device as claimed in claim 1, further comprising a spacing member, wherein in the first direction, the spacing member is disposed between the second surface of the connecting member and the connecting portion of the supporting member.

3. The electronic device as claimed in claim 2, further comprising a fixing member, wherein in the first direction, the connecting member of the touch module and the connecting section of the supporting member of the actuator module are connected to each other via the fixing member, and the fixing member passes through the spacing member.

4. The electronic device as claimed in claim 2, wherein the spacing member has a semicircular structure.

5. The electronic device as claimed in claim 2, further comprising a plurality of fixing members, wherein the fixing members pass through the connecting member and engage with the connecting section, and the fixing members do not pass through the spacing member.

6. The electronic device as claimed in claim 1, wherein the connecting member comprises a first protruding portion, and the first protruding portion protrudes toward the supporting member, wherein the first protruding portion comprises a third surface, the third surface is connected to the second surface, and compared to the second surface, the third surface is closer to the supporting member.

7. The electronic device as claimed in claim 6, further comprising a fixing member, wherein in the first direction, the first protruding portion of the connecting member and the connecting section of the supporting member are connected to each other via the fixing member.

8. The electronic device as claimed in claim 6, wherein the connecting member comprises a plurality of first protruding portions with a space between them.

9. The electronic device as claimed in claim 1, wherein the connecting portion further comprises a first inclined section and a second inclined section, the first inclined section is connected between the connecting section and the third end portion, the second inclined section is connected between the connecting section and the fourth end portion, and the connecting section and the first inclined section have different extending directions.

10. The electronic device as claimed in claim 9, wherein the connecting section of the supporting member comprises a second protruding portion, a first sub-protrusion connecting section, and a second sub-protrusion connecting section, and the second protruding portion protrudes toward the connecting member,
wherein the first sub-protrusion connecting section is connected between the first inclined section and the second protruding portion at a first connecting point, and the second sub-protrusion connecting section is connected between the second protruding portion and the second inclined section at a second connecting point,
wherein the first gap is formed between the first connecting point of the connecting section and the second surface of the connecting member.

11. The electronic device as claimed in claim 10, wherein in a second direction, in the supporting member, a distance between the second protruding portion and the first inclined section is in a range between 1 millimeter and 20 millimeters, and the first direction is different from the second direction.

12. The electronic device as claimed in claim 10, wherein the connecting section of the supporting member comprises two adjacent protruding portions and a depression portion, the depression portion is connected between the two adjacent protruding portions, and the depression portion is depressed in a direction that is away from the connecting member.

13. The electronic device as claimed in claim 10, wherein the connecting section further comprises a sub-connecting section connected between the first inclined section and the first sub-protrusion connecting section, and an extending direction of the sub-connecting section is perpendicular to an extending direction of the first sub-protrusion connecting section.

14. The electronic device as claimed in claim 13, wherein the extending direction of the sub-connecting section is different from the extending direction of the first inclined section.

15. The electronic device as claimed in claim 1, wherein the first surface and the second surface of the connecting member are opposite each other.

16. The electronic device as claimed in claim 1, wherein the first surface and the second surface of the connecting member are adjacent to one another.

17. The electronic device as claimed in claim 1, wherein the touch module further comprises a housing, and the housing comprises an accommodating portion,
wherein the first surface of the connecting member is connected to the touch panel via the housing, and at least a portion of the connecting member is accommodated in the accommodating portion.

18. The electronic device as claimed in claim 17, wherein the electronic device further comprises a locking member, and in a third direction, the connecting member and the housing are connected to each other via the locking member, wherein the first direction is different from the third direction.

19. The electronic device as claimed in claim 1, wherein the first gap is in a range between 0.1 millimeters and 10 millimeters.

20. The electronic device as claimed in claim 1, further comprising an additional connecting member and an additional supporting member, wherein in the first direction, the additional supporting member is disposed between the actuator member and the additional connecting member, and the actuator member is disposed between the supporting member and the additional supporting member.
